(19) United States
(12) Patent Application Publication
(10) Pub. No.: US 2018/0292983 A1
(43) Pub. Date: Oct. 11, 2018

(54) METHODS AND SYSTEMS FOR ASSIGNING ASSET SENSOR TAGS TO ANALYTIC INPUT PORTS

(71) Applicant: General Electric Company, Schenectady, NY (US)

(72) Inventors: Raneath Omega NOR, San Ramon, CA (US); Chandra PINJALA, San Ramon, CA (US); Chad ACKERMAN, San Ramon, CA (US); Alok GUPTA, San Ramon, CA (US); Yogini PARKHI, San Ramon, CA (US); Fred SCHULTS, San Ramon, CA (US); Ashley FERGUSON, San Ramon, CA (US)

(21) Appl. No.: 15/479,909

(22) Filed: Apr. 5, 2017

(51) Int. Cl. G06F 3/0484; G06F 3/0482

(52) U.S. Cl. CPC G06F 3/04847; G06F 3/0482

(57) ABSTRACT

Computer-implemented methods for mapping sensor tags of assets to input ports of an analytic process are disclosed. In an embodiment, a processor receives a selection by a user of an analytic process to run on a plurality of assets, automatically maps the analytic input ports of the selected analytic process to sensor tags of each of the plurality of assets that have matching tag names, and determines which analytic input ports have not been fully mapped. The processor then provides a map by asset option and a map by tag option to the user device, receives a selection of the map by asset option, provides an unmapped assets list including at least one asset that is not fully mapped and a list of tag alias names, and then receives a selection from the user device of an asset from the unmapped assets list along with selections of tag alias names mapped to the unmapped analytic input ports of the selected analytic process. In some embodiments, the processor next determines that all of the unmapped assets have been mapped, runs the selected analytic process, and provides an analytic output to the user device.

### BACKGROUND

Machine and equipment assets, generally, are engineered to perform particular tasks as part of a business process. For example, assets can include, among other things and without limitation, industrial manufacturing equipment on a production line, drilling equipment for use in mining operations, wind turbines that generate electricity on a wind farm, transportation vehicles such as aircraft and/or locomotives, and the like. As another example, assets may include healthcare machines and equipment that aid in diagnosing patients such as imaging devices (e.g., X-ray or MRI systems), monitoring devices, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing systems and processes, the increase in sensor capabilities along with the decrease in sensor costs, as well as the proliferation of mobile technologies, have created opportunities for creating novel industrial and/or healthcare based assets with improved sensing technology which are also capable of transmitting data that can then be distributed throughout a network. As a consequence, new opportunities exist for enhancing the business value of such assets through the use of novel industrial-focused hardware and software.

One of the difficulties in designing a computing platform that supports machine focused software is the amount and the variety of applications and data that may be of interest to a user through the platform. For example, a power plant operator or user may be interested in viewing and interacting with numerous applications and/or systems related to the power plant in order to manage and/or view attributes or assets such as generators, cooling towers, a plant floor, materials, alerts, fuel usage, power protection, power distribution, control systems, and/or the like. The operator may also wish to run one or more analytics processes using sensor(s) data in order to better understand any problems that arise (or that could occur).

During real world operation of an industrial asset, a large amount of operating data and/or service data and/or maintenance data is typically generated by sensors associated with each of the assets and/or components and/or other equipment. In addition, machine data is inherently different from user-created data and thus must be handled in a different manner. In particular, sensors associated with various machines can produce data streams much faster than a human or user. For example, the “GE90” jet engine manufactured by the GE Aviation division of the General Electric Company is capable of producing about one terabyte (1 TB) of data during takeoff and landing, which typically lasts only a few minutes. The GE90 engine has close to five thousand (5000) sensors configured for recording sub-second sensor values.

In order to run industrial analytics programs on the data produced by industrial machine sensors, such as the sensors in the GE90 jet engine, user knowledge is typically required concerning the time-series data streams (generated by one or more sensors) associated with each piece of equipment and/or with each process of the machine. Thus, some industries utilize standardized tag names (or standardized sensor tags) which can greatly simplify mapping the time series data to the correct analytics input port (by matching the correct sensor tag or tag name) to a particular input of the analytics program. However, a typical industrial environment such as a packaging line, a power generation network, or a chemical plant, can include many different types of equipment from many different manufacturers, and may include assets of different ages (it is not unusual for some industrial equipment to operate for decades). In addition, such industrial environments may include a number of control and/or automation systems from different vendors or manufacturers. In such cases, the types of sensors utilized and their associated signal names and/or sensor tags can be confusing to decipher by a user, especially if the sensor tag names are from an industry that does not utilize standardized sensor tag names. For example, an engineer working at an energy production facility may know that the particular sensor tag “AC03.Air_Flow” is related to a particular sensor associated with wind turbine A in Italy (and not to pump B in Denmark) and that it provides a particular type of data stream, but a data scientist trying to run an analytics program on wind turbine A may not have that knowledge. Thus, it can be very difficult to communicate with and/or obtain desired sensor output data (for example, to use as data inputs to an analytic program) associated with particular assets (such as industrial equipment), especially for an industry in which no single tag naming standard exists.

Furthermore, similar assets may not be similarly instrumented. For example, one particular asset may emit ten (10) data streams during operation while a second, similar asset emits only has only five (5) data streams, which makes analysis difficult unless the data is cleaned up to account for the difference(s). The lack of well-defined relational information was a minor issue when a single industrial site generated only a few hundred (or even a few thousand) data streams, but in the current industrial environment life can be painful for operators or users who need to the vast number of data streams generated by assets across one or more domains that do not have standardized sensor tag names. In such cases, users cannot rely on traditional asset models.

Currently, when executing an analytic algorithm for assets in a domain which all have multiple sensor data streams, sensor tag mapping is inevitable. In particular, to provide for the correct sensor data to flow into the analytic execution engine, users often have to painstakingly map tags to the analytic inputs of an analytics program one by one for each asset that the analytic program is being scheduled to run on. As mentioned above, some industries have predefined and/or standardized sensor tag names, and in such cases all applicable assets of a particular industrial domain can be quickly and efficiently mapped together. However, if there are outliers, which can include multiple assets that do not employ the same sensor tag naming convention, and/or assets that belong to many different manufacturers which each employ different sensor tag naming conventions, and/or assets acquired before sensor tag standardization occurred (such as very old machines and/or systems), then the sensor tags (or tag names) cannot be automatically mapped together, and any attempt at automatically mapping the assets of such a domain will result in the failure of the execution of the analytics program. Furthermore, such failures can be difficult to identify, and typically cannot be rectified unless the user maps each non-standard sensor tag name manually to the appropriate input port of the analytic program.

Thus, it would be desirable to provide systems and processes that take advantage of standardized tag names (or the standardized sensor tags) when available to automatically map to analytic input ports of an analytic program, while also identifying and then permitting users to quickly and easily manually map any outliers (or the non-standard sensor tags) to analytic inputs before running the analytics program.

### SUMMARY

Presented are novel methods and systems for mapping sensor tags of assets to input ports of an analytic process. In some embodiments, the process takes advantage of standardized tag names (or the standardized sensor tags) of assets, when available, to map the sensor tags to the input ports of a selected analytic process, while also permitting users to manually map non-standard sensor tags to the analytic input ports. In an implementation, a computer-implemented method includes receiving, by a processor from a user device, a selection by a user of an analytic process to run on a plurality of assets, then automatically mapping the analytic input ports of the selected analytic process to sensor tags of each of the plurality of assets that have matching tag names. The process also includes determining, by the processor, that the analytic input ports have not been fully mapped to the sensor tags of at least one asset, providing a map by asset option and a map by tag option to the user device for display to the user, receiving a selection of the map by asset option, providing, to the user device, an unmapped assets list comprising the at least one asset of the plurality of assets that are not fully mapped to the analytic input ports of the selected analytic process, and a list of tag alias names, and then receiving from the user device, a selection of an asset from the unmapped assets list and selections of tag alias names mapped by the user to the unmapped analytic input ports of the selected analytic process. The processor may also advantageously determine that all of the unmapped assets have been mapped, run the selected analytic process, and provide an analytic output to the user device.

In another advantageous embodiment, a computer-implemented method includes receiving, by the processor from the user device, a selection of the map by tag option (instead of the map by tag option), providing a list of unmapped analytic input ports and associated definitions, and a list of tag alias names associated with the assets to the user device, and receiving selections of analytic input tags mapped by the user to the tag alias names from the user device. In a beneficial implementation, the processor may determine that mapping of the analytic input ports to the tag alias names for each asset of the plurality of assets is complete, run the analytic algorithm, and provide analytic output data.

In an aspect of another example embodiment, there is provided a computer readable medium having stored therein instructions that when executed cause a computer to receive, from a user device, a selection of an analytic process to run on a plurality of assets, automatically map analytic input ports of the selected analytic process to sensor tags of each of the plurality of assets that have matching tag names, determine that the analytic input ports have not been fully mapped to the sensor tags of at least one asset of the plurality of assets, and provide a map by asset option and a map by tag option to the user device. Also included are instructions that when executed cause the computer to receive a selection of the map by asset option, provide an unmapped assets list that includes at least one asset of the plurality of assets that are not fully mapped to the analytic input ports of the selected analytic process, and a list of tag alias names, and to receive a selection of an asset from the unmapped assets list and selections of tag alias names mapped by the user to the unmapped analytic input ports of the selected analytics process from the user device. In some embodiments, the further instructions may be included which are configured to cause the computer to determine that mapping of sensor tags to the analytic input ports has been completed for each asset of the unmapped assets list, run the selected analytic process, and provide analytic output data to the user device.

Such embodiments provide a technical solution to the problem of how to take advantage of standardized tag names (or the standardized sensor tags) of a community of assets (to automatically map the sensor tags to the analytic input ports of a selected analytic process), while also permitting a user to efficiently, accurately and/or quickly manually map any non-standard sensor tags to the input ports of the selected analytic program. Accordingly, disclosed is an asset tag selection UI that presents simple and pleasant visual clues to guide the user in the right direction in order to utilize a “map by asset” process and/or a “map by analytic port” process to accurately and easily map (or assign) sensor tags to the available (or required) analytic input ports of the selected analytic process in a manner which can be easily understood by the user or operator. The disclosed processes also advantageously help to prevent human error that can otherwise occur during the mapping process, which errors may not be discovered until later, for example, until after a selected analytic process runs on all of the assets of a domain and the results are analyzed (and in some cases, such human errors may be left undiscovered). The disclosed processes can be utilized within an industrial environment and/or other types of environments, and help to resolve current mapping problems and/or to predict future problems which could occur and act accordingly to prevent them.

Other features and aspects may be apparent from the following detailed description taken in conjunction with the drawings and the appended claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing environment associated with industrial systems in accordance with an example embodiment;

FIGS. 2A, 2B and 2C together form a flowchart illustrating a method for facilitating mapping of sensor tags of assets to analytic input ports in accordance with some embodiments;

FIG. 3 is a block diagram illustrating a sensor tag mapping service system for facilitating the mapping of analytic input ports to sensor tags in a cloud computing environment according to some embodiments;

FIG. 4 illustrates a computing device for facilitating mapping of analytic input ports to sensor tags of assets in accordance with an example embodiment; and

FIGS. 5A to 5M illustrate screen shots of an asset performance management (APM) analytics user interface (UI) screens in accordance with some embodiments.

Throughout the drawings and the detailed description, unless otherwise described, the same drawing reference numerals will be understood to refer to the same elements, features, and structures. In addition, the relative size and depiction of some elements may be exaggerated and/or adjusted for clarity, illustration, and/or convenience, and thus are not necessarily drawn to scale.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

In general, and for the purpose of introducing concepts of novel embodiments described herein, provided are methods and systems that take advantage of standardized tag names (or the standardized sensor tags) of assets, when available, to map sensor tags to input ports of an analytic process or analytic algorithm (or analytic program), while also permitting users to override the auto-mapping process (for example, by manually mapping non-standard sensor tags to the input ports of the analytic process). In some embodiments, an Asset Performance Management (APM) analytics program provides an asset tag selection user interface (UI) that allows users to automatically map standardized sensor tags to an analytic program's input ports, and that permits the users to “map by analytic port” and/or “map by asset” any non-standard sensor tags or non-standard sensor names to the analytic algorithm inputs. The asset tag selection UI permits the user to easily identify all of the sensor tags (or sensor names) associated with a plurality of sensors that are associated with one or more assets, for example in a domain selected by the user (i.e., all of the sensors related to wind turbines in a clean-energy generation domain). In addition, the asset tag selection UI permits the user to map the sensor tags in a simplified and efficient manner to the input ports of an analytic process. Thus, the methods and systems disclosed herein save time and effort as compared to conventional processes, which typically accomplished bulk tag mapping by using asset templates. In addition, some embodiments disclosed herein provide an asset tag selection UI that presents simple and pleasant visual clues to guide a user in the right direction in order to utilize the “map by asset” process and/or the “map by analytic port” process to accurately and easily map sensor tags to the available analytic input ports. Such processing also advantageously helps to prevent human error that can otherwise occur during the mapping process, which errors are often not discovered until much later, for example, after a selected analytic process runs on all of the assets of a domain and the results are analyzed (and in some cases, such human errors may be left undiscovered).

Although some examples of novel processes described herein relate to sensor data streams generated in association with industrial machines and/or the Industrial Internet of Things (IIoT), it should be understood that the novel processes described herein are domain agnostic (for example, the processes can be applied to sensor data associated with various industries, such as the aviation industry, hotel industry, transportation industry, healthcare industry, and the like).

While progress with machine and equipment automation has been made over the last several decades, and assets (such as industrial machines) have become ‘smarter,’ the intelligence of any individual asset pales in comparison to intelligence that can be gained when multiple smart devices are connected together, for example, in the cloud. Assets, as described herein, may refer to equipment and machines used in fields (or domains) such as energy, healthcare, transportation, heavy manufacturing, chemical production, printing and publishing, electronics, textiles, and the like. Aggregating data collected from or about multiple assets can enable users to improve business processes, for example by improving the effectiveness of asset maintenance or improving operational performance if appropriate industrial-specific data collection and modeling technology is developed and applied.

For example, an asset can be outfitted with one or more sensors configured to monitor respective operations or conditions. Data from the sensors can be recorded or transmitted to a cloud-based or other remote computing environment. By bringing such data into a cloud-based computing environment, new software applications informed by industrial process, tools and know-how can be constructed, and new physics-based analytics specific to an industrial environment and/or other types of environments can be created. Insights gained through analysis of such data can lead to enhanced asset designs, enhanced software algorithms for operating the same or similar assets, better operating efficiency, and the like. In addition, large amounts of sensor data may be generated and stored, including sensor data associated with the operations of assets, associated with operational capabilities of assets, and/or associated with assets which have malfunctioned.

Assets can include or can be a portion of an Industrial Internet of Things (IIoT). In an example, an IIoT connects assets including machines and equipment, such as turbines, jet engines, healthcare machines, locomotives, and the like, to the Internet or cloud, or to each other in some meaningful way, for example, through one or more networks. The systems and methods described herein can include using a “cloud” or remote or distributed computing resource or service. The cloud can be used to receive, relay, transmit, store, analyze, and/or otherwise process information for or about one or more assets. In an example, a cloud computing system includes at least one processor circuit, at least one database, and a plurality of users and/or assets that are in data communication with the cloud computing system. The cloud computing system can further include, or can be coupled with, one or more other processor circuits or modules configured to perform a specific task, such as to perform tasks related to asset maintenance, asset analytics, asset data storage, security, and/or some other function(s).

However, the integration of assets with the remote computing resources to enable the IIoT often presents technical challenges separate and distinct from the specific industry and from computer networks, generally. A given machine or equipment based asset may need to be configured with novel interfaces and/or communication protocols to send and receive data to and from distributed computing resources. Certain assets may have strict requirements for cost, weight, security, performance, signal interference, and the like such that enabling such an interface is rarely as simple as combining the asset with a general purpose computing device. In addition, assets are in real-world operation and thus may generate a large amount of servicing data and/or operational data over time, which data is stored and is retrievable and needs to be presented in a manner that enables an end user, for example, to view the data in order to maintain assets, solve problems as they arise, and/or prevent issues from occurring. In addition, as mentioned above, sensors associated with various assets of a domain may have non-standard sensor tags which can make it difficult to map the sensor output data streams to the correct input port of an analytics program.

The Predix™ platform available from the General Electric Company (GE) is a novel embodiment of an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. In some embodiments, the Predix™ platform is a cloud-based IoT platform that permits the use of analytic algorithms developed for a specific domain to be utilized for assets across other domains. Accordingly, such cloud-based platforms make it possible to develop general purpose analytic algorithms to use across domains, and mapping can thus occur from the context of a well-known analytic algorithm when attempting to utilize it to analyze data from a different or new domain. Through the use of such a system, a manufacturer of assets can be uniquely situated to leverage its understanding of assets themselves, models of such assets, and industrial operations or applications of such assets, to create new value for industrial customers through asset insights in one or more domains.

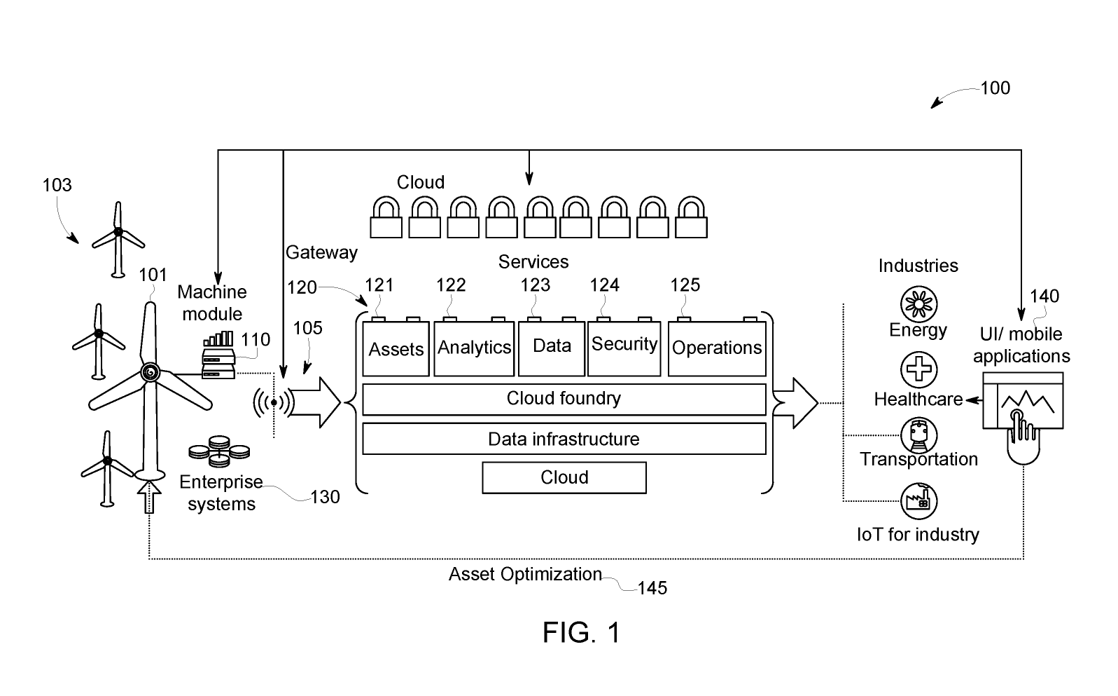

FIG. 1 illustrates a cloud computing environment associated with industrial systems in accordance with an example embodiment. FIG. 1 generally illustrates an example of portions of an asset management platform (AMP) 100. As further described herein, one or more portions of an AMP can reside in a cloud computing system 120, in a local or sandboxed environment, or can be distributed across multiple locations or devices. The AMP 100 can be configured to perform any one or more of data acquisition, data storage, data analysis, and/or data exchange with local or remote assets, or with other task-specific processing devices. The AMP 100 includes an asset community (e.g., turbines, healthcare machines, industrial, manufacturing systems, etc.) that is communicatively coupled with the cloud computing system 120. In an example, a machine module 110 receives information from, or senses information about, at least one asset member of the asset community 103, and configures the received information for exchange with the cloud computing system 120. In an example, the machine module 110 is coupled to the cloud computing system 120 and/or to an enterprise computing system 130 via a communication gateway 105.

In some embodiments, the communication gateway 105 includes or uses a wired or wireless communication channel that extends at least from the machine module 110 to the cloud computing system 120. The cloud computing system 120 may include several layers, for example, a data infrastructure layer, a cloud foundry layer, and modules for providing various functions. In the example shown in FIG. 1, the cloud computing system 120 includes an asset module 121, an analytics module 122, a data acquisition module 123, a data security module 124, and an operations module 125. Each of these modules includes or uses a dedicated circuit, or instructions for operating a general purpose processor circuit, to perform the respective functions. In an example, the modules 121-125 are communicatively coupled in the cloud computing system 120 such that information from one module can be shared with another. In an example, the modules 121-125 are co-located at a designated datacenter or other facility, or the modules 121-125 can be distributed across multiple different locations.

An interface device 140 (e.g., user device, workstation, tablet computer, laptop, appliance, kiosk, and the like) can be configured for data communication with one or more of the machine module 110, the gateway 105, and the cloud computing system 120. The interface device 140 can be used to monitor and/or control and/or run analytics algorithms on one or more assets. As another example, the interface device 140 may be used to develop and upload applications to the cloud computing system 120. As yet another example, the interface device 140 may be used to access analytical applications hosted by the cloud computing system 120. In some embodiments, information about the asset community 103 may be presented to an operator at the interface device 140. The information about the asset community may include information from the machine module 110, and/or the information can include information from the cloud computing system 120. The interface device 140 may include a display component 142 (for example, a touch screen display) that can be utilized to display an asset performance management (APM) analytics user interface (UI) to the user, which includes options for selecting one or more analytics programs, and options for mapping signal tags associated with one or more assets to the input ports of a selected analytic program. In addition, the interface device 140 can include options for optimizing one or more members of the asset community 103 based on output results obtained from analytics performed at the cloud computing system 120.

As a non-limiting example, an end user of the interface device 140 may control an asset through the cloud computing system 120, for example, by selecting a parameter update for a first wind turbine 101 of the asset community 103. In this example, the parameter update may be pushed to the first wind turbine 101 via one or more of the cloud computing system 120, the gateway 105, and the machine module 110. In some examples, the interface device 140 is in data communication with the enterprise computing system 130 and the interface device 140 provides an operation with enterprise-wide data about the asset community in the context of other business or process data. For example, choices with respect to asset optimization can be presented to an operator in the context of available or forecasted raw material supplies or fuel costs. As another example, choices with respect to asset optimization can be presented to an operator in the context of a process flow to identify how efficiency gains or losses at one asset can impact other assets.

In another non-limiting example, after utilizing an APM analytics UI to map sensor tag names of assets of a domain to the analytic input ports for an analytic as disclosed herein, an end user of the interface device 140 may obtain analytics output data through the cloud computing system 120. For example, the end user may obtain analytic output data concerning multiple wind turbine assets of the asset community 103, including the first wind turbine 101. However, it should be understood that wind turbines in an asset community 103 are merely used in this example as a non-limiting example of a type of asset that can be a part of, or in data communication with, the asset management platform (AMP) 100. Thus, other types of industrial assets may also be associated with the AMP 100. The end user can then, based on the analytics output data, initiate a parameter update by pushing the update to the first wind turbine 101 via one or more of the cloud computing system 120, the gateway 105, and the machine module 110 and then to other assets associated with the asset community of wind turbines.

Referring again to FIG. 1, a device gateway 105 is configured to couple the asset community to the cloud computing system 120. In some implementations, the device gateway 105 can also couple the cloud computing system 120 to one or more other assets or asset communities, to the enterprise computing system 130, or to one or more other devices. The AMP 100 thus represents a scalable industrial solution that extends from a physical or virtual asset (e.g., the first wind turbine 101) to a remote cloud computing system 120. The cloud computing system 120 optionally includes a local, system, enterprise, or global computing infrastructure that can be optimized for industrial data workloads, secure data communication, and compliance with regulatory requirements.

The cloud computing system 120 can include the operations module 125. The operations module 125 can include services that developers can use to build or test Industrial Internet applications, and the operations module 125 can include services to implement Industrial Internet applications, such as in coordination with one or more other AMP modules. In an example, the operations module 125 includes a microservices marketplace where developers can publish their services and/or retrieve services from third parties. In addition, the operations module 125 can include a development framework for communicating with various available services or modules. The development framework can offer developers a consistent look and feel and a contextual user experience in web or mobile applications. Developers can add and make accessible their applications (services, data, analytics, etc.) via the cloud computing system 120.

Information from an asset, about the asset, or sensed by an asset itself may be communicated from the asset to the data acquisition module 123 in the cloud computing system 120. For example, one or more external sensors can be used to sense information about a function of an asset, or to sense information about environmental conditions at or near an asset. Such external sensors can be configured for data communication with the device gateway 105 and with the data acquisition module 123. The cloud computing system 120 can also be configured to use sensor information in its analysis of one or more assets, for example, by using the analytics module 122. Using a result from the analytics module 122, an operational model can optionally be updated, for example, for subsequent use to optimize the first wind turbine 101 or one or more other assets, such as one or more assets in the same or different asset community. For example, information about the first wind turbine 101 can be analyzed at the cloud computing system 120 to inform selection of an operating parameter for a remotely located second wind turbine that belongs to a different asset community.

The cloud computing system 120 may include a Software-Defined Infrastructure (SDI) that serves as an abstraction layer above any specified hardware, which can enable a data center to evolve over time with minimal disruption to overlying applications. The SDI enables a shared infrastructure with policy-based provisioning to facilitate dynamic automation, and enables service level agreement (SLA) mappings to underlying infrastructure. This configuration can be useful when an application requires an underlying hardware configuration. The provisioning management and pooling of resources can be done at a granular level, thus allowing optimal resource allocation. In addition, the asset cloud computing system 120 may be based on Cloud Foundry (CF), an open source platform-as-a-service (PaaS) that supports multiple developer frameworks and an ecosystem of application services. Cloud Foundry can make it faster and easier for application developers to build, test, deploy, and scale applications. In such embodiments, developers gain access to the vibrant CF ecosystem and an ever-growing library of CF services. Additionally, because it is open source, CF can be customized for industrial Internet of Things (IIoT) workloads.

In addition, the cloud computing system 120 can include a data services module that can facilitate application development. For example, the data services module can enable developers to bring data into the cloud computing system 120 and to make such data available for various applications, such as applications that execute at the cloud, at a machine module, or at an asset or other location. In an example, the data services module can be configured to cleanse, merge, or map data before ultimately storing it in an appropriate data store, for example, at the cloud computing system 120. In some embodiments, special emphasis is placed on time series data, as it is the data format that most sensors use.

Security can be a concern for data services that exchange data between the cloud computing system 120 and one or more assets or other components. Some options for securing data transmissions include using Virtual Private Networks (VPN) or a secure socket layer (SSL)/transport layer security (TLS) model. In an example, the AMP 100 can support two-way TLS, such as between a machine module and the security module 124. In another example, two-way TLS may not be supported, and the security module 124 can treat client devices as Open Authorization (OAuth) users. For example, the security module 124 can allow enrollment of an asset (or other device) as an OAuth client and transparently use OAuth access tokens to send data to protected endpoints.

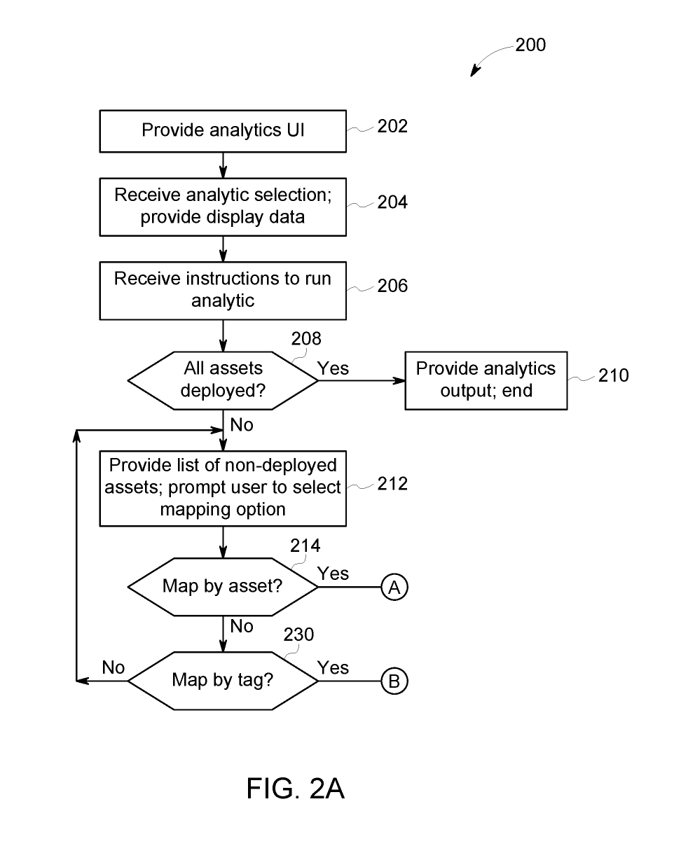

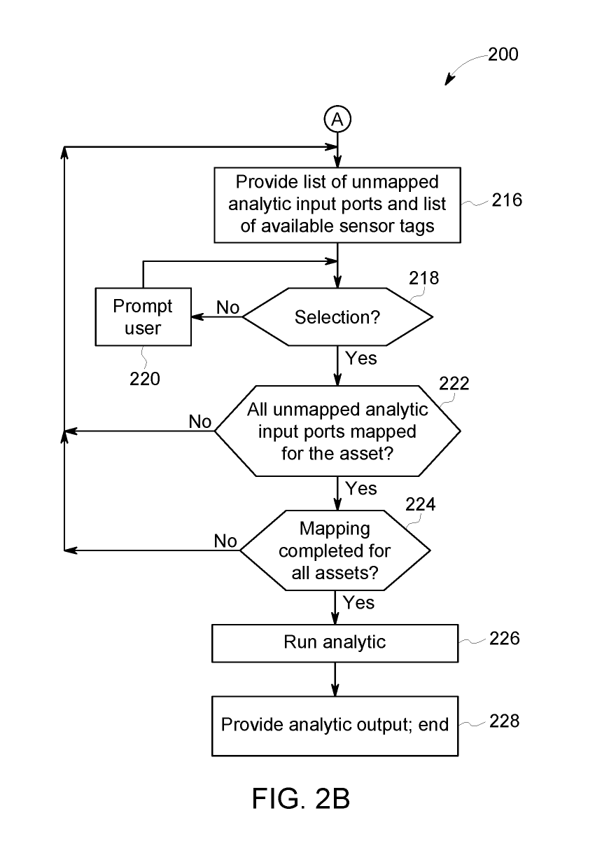

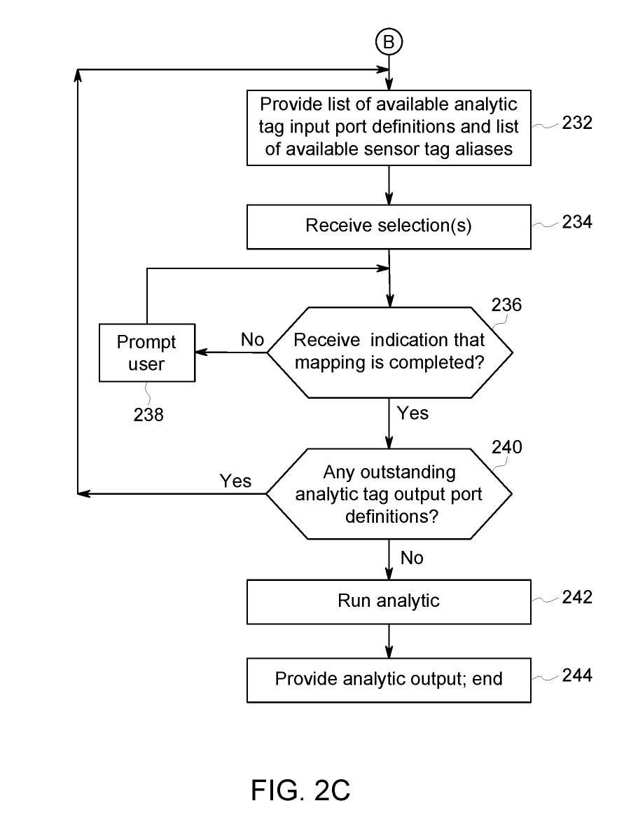

FIGS. 2A, 2B and 2C together form a flowchart 200 illustrating a method for facilitating mapping of sensor tags of assets of a domain to analytic input ports in accordance with the disclosure. In particular, a user may utilize an interface device or user device 140 (such as a laptop computer, smartphone or a tablet computer) to access a cloud computing system 120 and bring up an Asset Performance Management (APM) user interface (UI) on a display screen that includes various options, including an analytics catalog option. The analytics catalog may include a number of stored analytics algorithms for use in determining analytic data for one or more assets of, for example, an industrial domain. Upon user selection of the analytics catalog option, a processor of the cloud computing system 120 provides 202 an Analytics UI which includes a list of analytic programs. When the processor receives 204 an analytic program selection from the user, the processor provides analytics program data, such as information concerning asset applicability, input definition(s), and constants, for display to the user on the display component of the interface device 140. In some embodiments, the user may also be prompted to designate a plurality of assets (for example, of an asset community) or prompted to designate one or more domains of assets upon which the analytics program will be run. Next, the processor receives 206 an instruction to run the analytic program and to generate an output. If all of the assets were deployed 208, meaning that all of the analytic input ports were successfully mapped to sensor tags of each asset and that the analytic program ran successfully on all of the assets, then the processor provides 210 an analytics output and the process ends. However, if all of the assets were not deployed 208, then the processor provides 212 a list of non-deployed assets and prompts the user to select a sensor tag mapping option. In some embodiments, two mapping options are available: a “map by asset” option and a “map by tag” option.

In some embodiments, the process 200 provides the user with visual indications that inform the user if a given analytical input port has been fully mapped for all of the applicable assets (for example, all assets of an asset community or of a domain), or if a given analytical port has been partially mapped, meaning that the particular analytical input port has been mapped for all assets where matching sensor tags were found, but that outliers exist (which means that one or more assets have no matching sensor tag for that analytic input port). In some embodiments, the process may also provide the user with a visual indication informing the user that a particular analytical input port has not been mapped at all, which means that no time series tags of the assets have been mapped for a given analytic input. It should be understood that all analytic algorithms have a set of required inputs, but that some may also have one or more optional inputs. Therefore, in some implementations of the novel processes described herein, only the required analytic inputs are considered when determining the “mapped status” of a particular analytic algorithm.

Referring again to FIG. 2A, if the user selects 214 the map by asset option, then as shown in FIG. 2B, the processor provides 216 a list of one or more unmapped analytic inputs and the available sensor tags of an asset of the community of assets. In some embodiments, if the user selection 218 is not made within a predetermined amount of time, then the processor prompts 220 the user to make a mapping selection of an unmapped analytic input to an available sensor tag (or sensor tag alias). If, after the user is prompted 220 no selection is made within a second predetermined amount of time, then in some implementations the process ends and the user may be informed of the termination of the process. However, when a user makes a selection in step 218, then the processor checks 222 to ensure that all analytic inputs are mapped for that asset. If not, then the process loops back to step 216, wherein the processor again provides a list of the one or more unmapped analytic inputs which remain and the available sensor tags for that asset. These steps 216-222 are then repeated until all of the analytic input ports have been mapped to sensor tags of that asset. In some embodiments, a search and filter capability is provided to help the user quickly identify the sensor tags to map.

Referring again to FIG. 2B, if the processor determines in step 222 that all of the unmapped analytic ports have been mapped to sensor tags for the asset, then the process continues with the processor determining 224 whether or not mapping is required for another asset. If so, then the process again loops back to step 216 wherein the processor provides a list of unmapped analytic port inputs for that additional asset. Such processing occurs until the processor determines 224 that mapping has been completed for all of the assets of the domain (or community of assets), in which case the processor runs 226 the analytics program and provides 228 an analytic output.

In some embodiments, the user can perform a similar mapping process on the outputs of an analytic algorithm as well. For example, in an implementation, automatically-created output tags can be utilized by the user to store the output time series data produced by the analytic algorithm. Alternately, some implementations permit the user to map analytic algorithm output tags to an existing sensor tag of an asset.

Referring again to FIG. 2A, if in step 214 the user does not select the map by asset option, then the processor may receive 230 a user selection of the “map by tag” option. If, however, a predetermined amount of time expires and the processor has not received a selection of either the “map by asset” option or the “map by tag” option, the process may loop back to step 212 wherein the processor again prompts the user to select a mapping option. In some embodiments, if a second predetermined amount of time expires without the user selection, then the process may end, and the user may be provided with an indication that the analytic program will not proceed because there are there are non-deployed assets. In addition, the analytic configuration may be persisted (or suspended) and marked as “Not Fully Mapped” in order to give the user an opportunity to come back at a later time to finish mapping.

An analytic algorithm that is not in a “fully mapped” state cannot be executed through APM Analytics UI, and thus users understand that it will fail because all the required data is not available. Accordingly, in some embodiments the APM Analytics UI visually marks or highlights the analytic algorithm input(s) that require attention (for example, by presenting such inputs in red on the user's display screen) to help the user navigate the “incomplete” mapping. Accordingly, in step 216 of the “map by asset” process shown in FIG. 2B, the APM Analytics UI may visually present the unmapped analytic inputs associated with the incomplete (not fully mapped) assets in a manner to help a user to complete mapping.

Referring again to FIG. 2A, if the user selects 230 the map by tag option, then as shown in FIG. 2C the processor provides 232 a list of analytic input tag definitions and a list of available sensor tag aliases (sensor names) associated with the assets of the domain (or community of assets). The processor then receives 234 selection(s) of analytic input tag definitions and associated tag aliases, and monitors for an indication 236 from the user that the user has completed the mapping process. If such an indication is not received within a predetermined amount of time (that begins when mapping activity has ceased), then the processor prompts 238 the user to continue with mapping, and the processor again monitors for an indication 236 from the user that the user has completed the mapping process. In some embodiments, if a further predetermined amount of time expires without mapping activity and/or an indication from the user that mapping has ceased, then the process may end and an indication provided to the user that the analytics mapping process has not been completed. However, in some implementations, the incomplete or “not fully mapped” state can be persisted so that the user can come back at a later time and complete mapping. In addition, in some embodiments the user experience or UX design permits users to click and navigate to other micro applications in the APM Analytics UI in order to gather information needed to derive the correct mapping for a particular analytic algorithm and then to come back to complete the missing input mappings. Also, as mentioned above, the user may be guided with visual cues that highlight the “incomplete” analytic input ports and/or assets.

Referring again to step 236 of FIG. 2C, when the processor receives an indication that the user is finished with the mapping process, then the processor determines 240 if there are any outstanding analytic tag input ports for any of the assets of the domain that still need to be mapped. If so, then the process branches back to step 232 and the processor provides another list of the available sensor tag aliases, receives selections 234, and monitors 236 again for an indication from the user that the user has finished mapping. If the processor then determines 240 that there are no outstanding analytic input ports left to map with regard to the domain (or community of assets), the processor runs 242 the analytic program and provides 244 an analytic output. The process then ends.

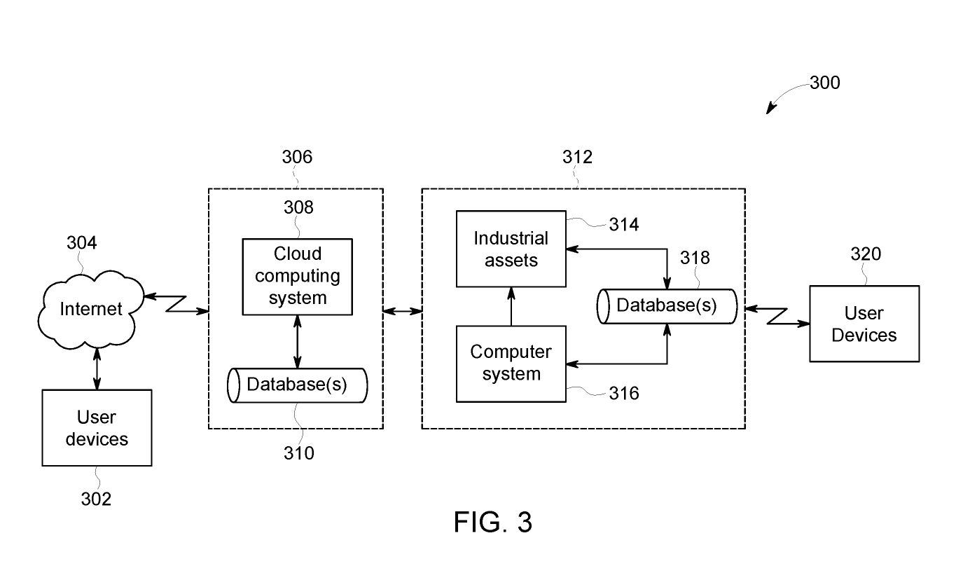

FIG. 3 is a block diagram illustrating a sensor tag mapping service system 300 for facilitating the mapping of analytic input ports to sensor tags in a cloud computing environment according to some embodiments. The system 300 includes end user devices 302 in communication with a cloud platform 306 via the Internet 304. However, it should be understood that another type of network, such a private network, could be utilized to operably connect one or more end user devices 302 to the cloud platform instead of, or in combination with, the Internet 304. End user devices 302 can be any type of communication device, such as a smart phone, tablet computer, laptop computer, a workstation, an appliance and the like. In this example, the cloud platform 306 includes a cloud computer system 308 (which may include one or more computer servers) and at least one database 310 which stores instructions and/or data, such as sensor data and/or sensor tag information. The cloud platform 304 is shown in communication with an industrial domain 312 that includes a plurality of Industrial Assets 314 (such as a number of wind turbines, which may also be thought of as a community of assets) operably connected to a computer system 316, and both may be operably connected to one or more database(s) 318. The computer system 316 may include one or more server computers and/or network computers, and may operate to obtain and store various types of data associated with the industrial assets 314 in the database 318. Such stored data can include sensor streams and/or historical sensor data originating from one or more sensors which have been deployed to monitor conditions associated with the industrial assets 316. In addition, a plurality of user devices 320 may be in direct communication with the industrial domain 312 via a network (not shown, which may also include the Internet 304, and which may accommodate users who are tasked with monitoring and/or maintaining the industrial assets. It should be understood that, for the sake of simplicity only one industrial domain 312 is shown in FIG. 3, but in reality a plurality of domains may be included, wherein each domain is in communication with the cloud platform 306 and operable to provide many different types of data, including sensor data.

In some embodiments, the cloud computing system 308 of the cloud platform 306 also stores analytic algorithm output data in a persistent storage device or persistent memory such that the output data structures can continue to be accessed, for example, by the user utilizing memory instructions and/or memory application programming interfaces (APIs) even after the end of the analytic process that created them. In some embodiments, such analytic output data is persisted as time series data which was stored by and/or in a time series storage device (which may be composed of on one or more database(s) 310), and such stored analytic output data can then be utilized for further analysis. In some embodiments, mapping of the analytic output data to an Asset Model can be accomplished by the user, and the visual design of the process(es) described herein helps users with mapping the analytic output ports to predetermined Asset Model key performance indicators (KPIs) or calculated tags associated with an Asset. For example, in order to determine the efficiency and/or total production of an asset over time, a time series of sensor output data may be stored and then utilized to calculate a score or determine a value that indicates the efficiency and/or total production value of that asset over a particular time period. For example, a pump analytic algorithm may run at noon every day for three months, calculate an efficiency value each day for a given pump from sensor data associated with a pump, and write back a record of the efficiency value with a timestamp into a storage device each day for the pump. These efficiency values constitute key performance indicators (KPIs) for the pump, and can be used to further analyze the performance on this pump over time. For example, the efficiency of the pump can be calculated by the pump analytic algorithm by utilizing the time series pump sensor data that has been stored over time. In an example of a calculated tag, the water cut in an oil field can be measured or calculated by aggregating the measurements taken by each pump of control (POC) associated with an oil well (which goes to a central purifier and a meter). Thus, the water cut at the meter can be calculated by adding up or aggregating water cut from each of the wells feeding into it, which value may be characterized as a calculated tag and stored in a time series storage device. Thus, in some embodiments the Asset Model Tag indicates the type of tag as sensor tags and calculated tags. (It should be noted that a KPI may be considered as a type of calculated tag.)

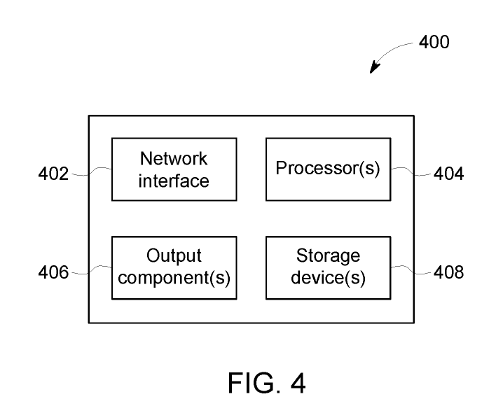

FIG. 4 illustrates a computing device 400 for facilitating mapping of analytic input ports to sensor tags of a community of assets in accordance with an example embodiment. In particular, the device 400 may be a cloud computing device in a cloud platform, or may be another device. In addition, in some embodiments the device 400 performs the method 200 of FIGS. 2A-2C.

Referring to FIG. 4, the device 400 includes a network interface 402, a processor 404, one or more output components 406, and one or more storage devices 408. Although not shown in FIG. 4, the device 400 may include other components such as a touch screen display, an input unit or device (such as a keyboard, for example), a receiver/transmitter component, and the like. The network interface 402 may transmit and receive data over a network such as the Internet, a private network, a public network, and/or the like. The network interface 402 may be a wireless interface, a wired interface, or a combination thereof. The processor 404 may include one or more processing devices each including one or more processing cores, and may include non-conventional processing devices specifically designed (or customized) to optimize the mapping of analytic input ports to sensor tags associated with one or more assets. In some examples, the processor 404 is a multicore processor or a plurality of multicore processors. Also, the processor 404 may be fixed or it may be reconfigurable. The output 406 may be configured to output data to an embedded display of the device 400 (such as a touchscreen), an externally connected display, a cloud, another device, and/or the like. The storage device 408 is not limited to any particular storage device, may be configured as a queue for storing the analytic output data as a time series, and may include any known memory device such as RAM, ROM, hard disk, bubble memory, flash memory, and the like.

According to some embodiments, the network interface 402 may receive a request for mapping the analytic input ports of a selected analytic algorithm or analytic program to the sensor tags or tag names associated with the assets of an asset community or domain, for example, from a user device. The request may include an indication of a particular domain and/or community of assets and/or a plurality of domains or communities of assets and/or other data. The processor 402 may then execute the steps required to facilitate mapping, including automatically mapping the analytic input ports to matching sensor tags, and providing a list or lists of analytic input ports that have not been mapped, which is then transmitted to the user's device and displayed on a display component of the user's device. In some embodiments, the user may then select a “map by asset” option and/or a “map by tag” option and then manually match outstanding analytic input ports associated with one or more assets having one or more sensor tags. In some implementations, after the processor 402 determines that all of the analytic input ports of the analytic program have been matched to the sensor tag names of the assets of the domain, the processor runs the analytic program and provides an analytic output. In some embodiments, the user can validate the analytic output data by executing the analytic algorithm with a small fixed sample dataset, and then comparing those results with the analytic output data obtained after mapping. Alternately, the user can simply choose to schedule execution of the analytic algorithm after mapping by designating an asset data time interval and a sample size. The analytic algorithm will then run at the designated time and produce analytic output data.

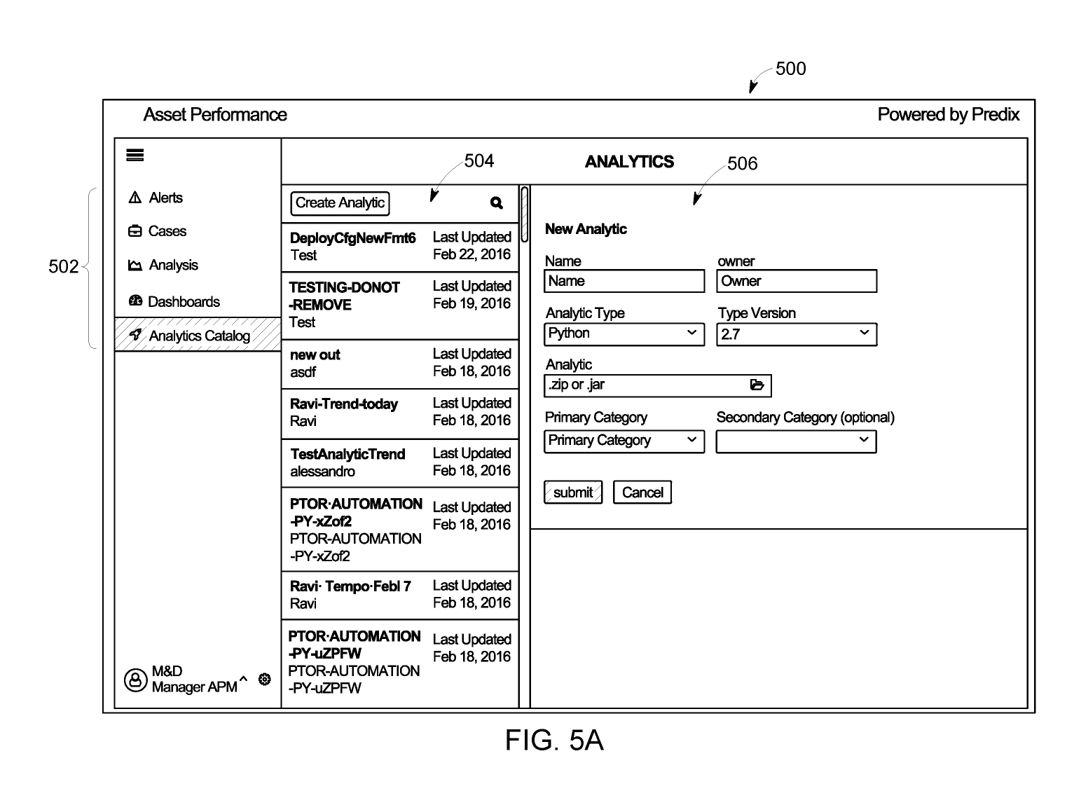

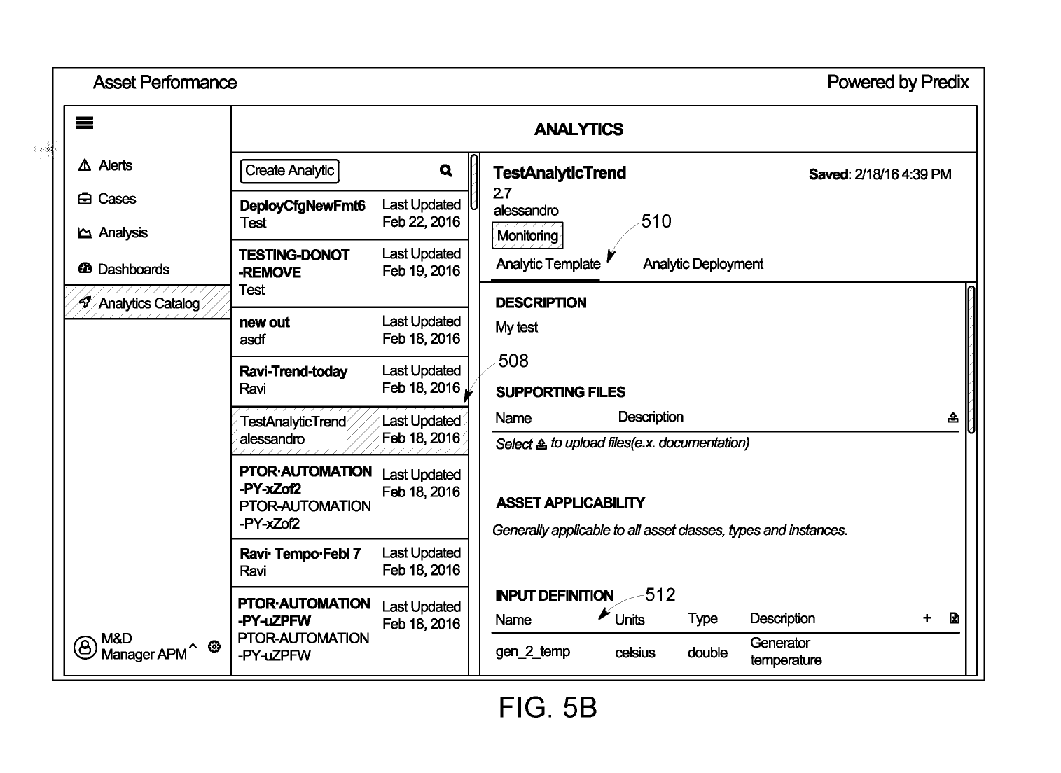

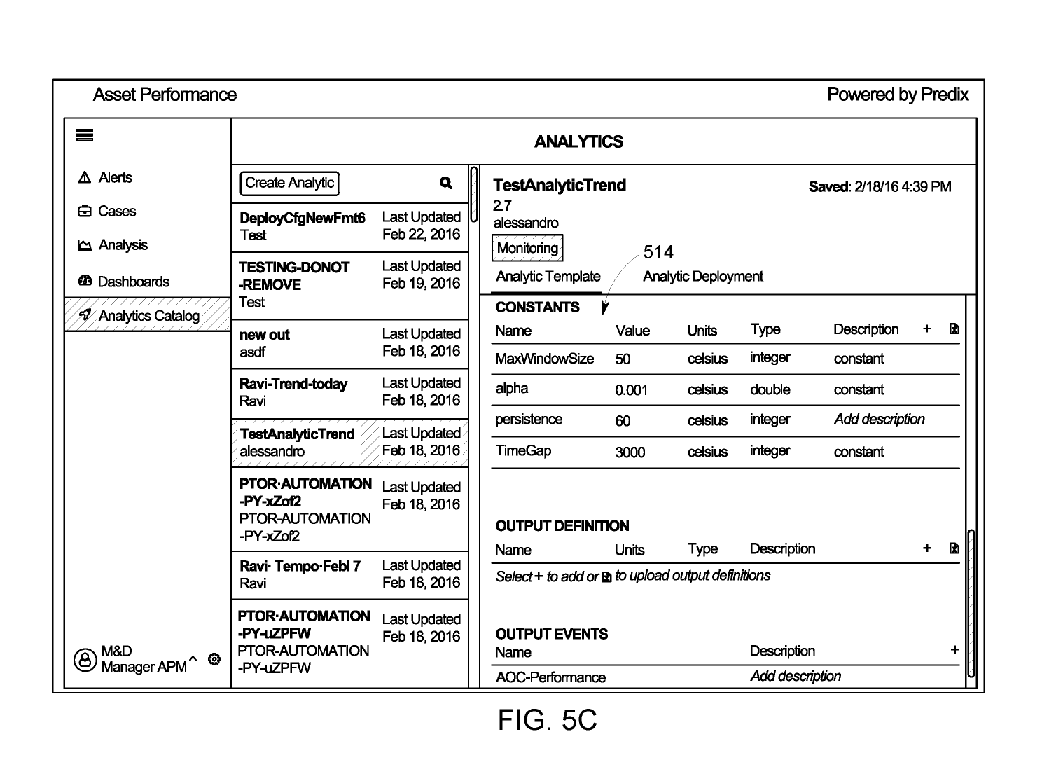

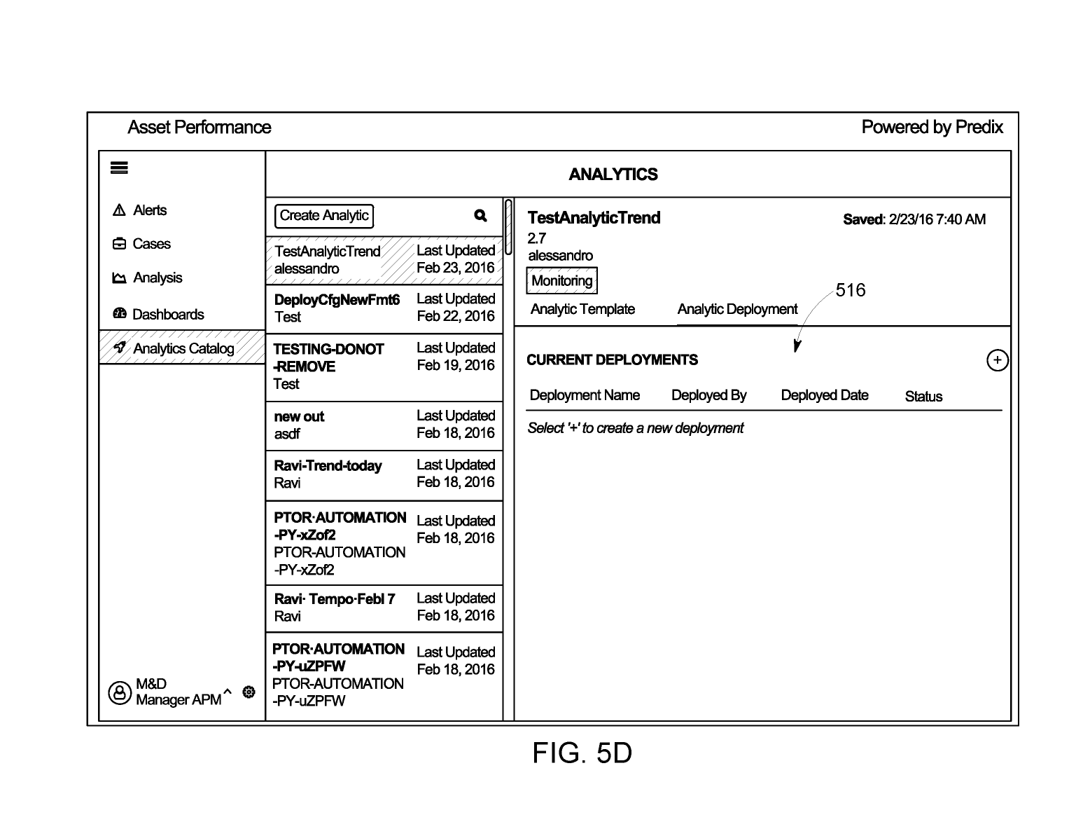

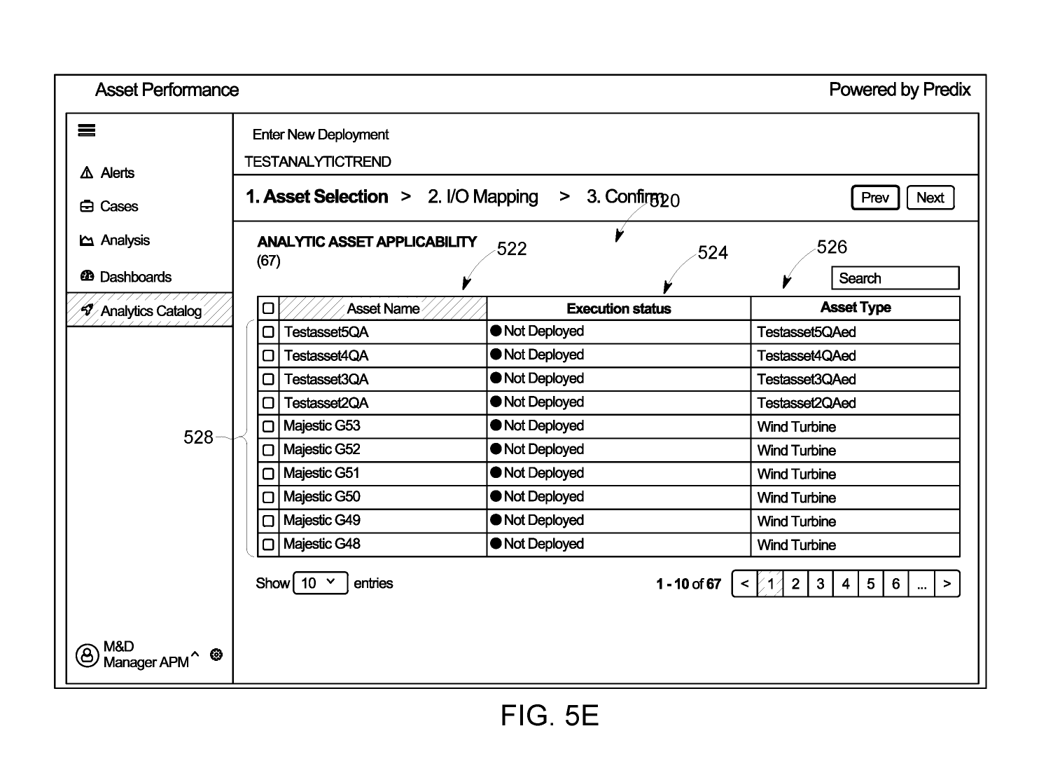

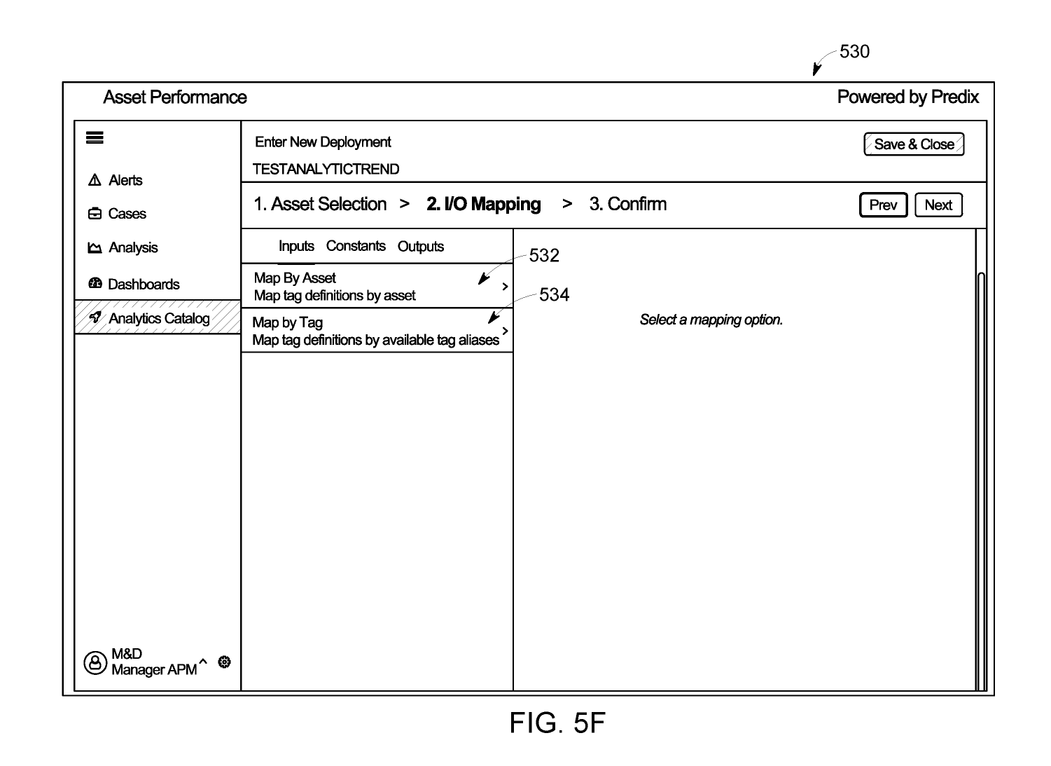

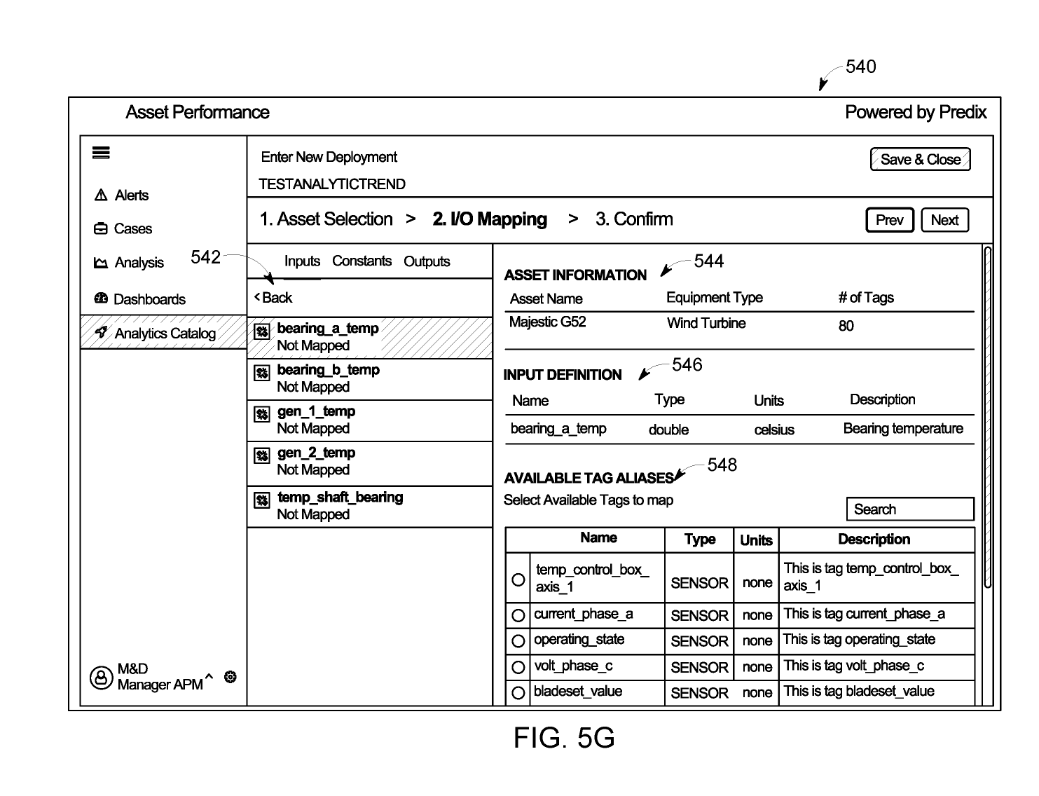

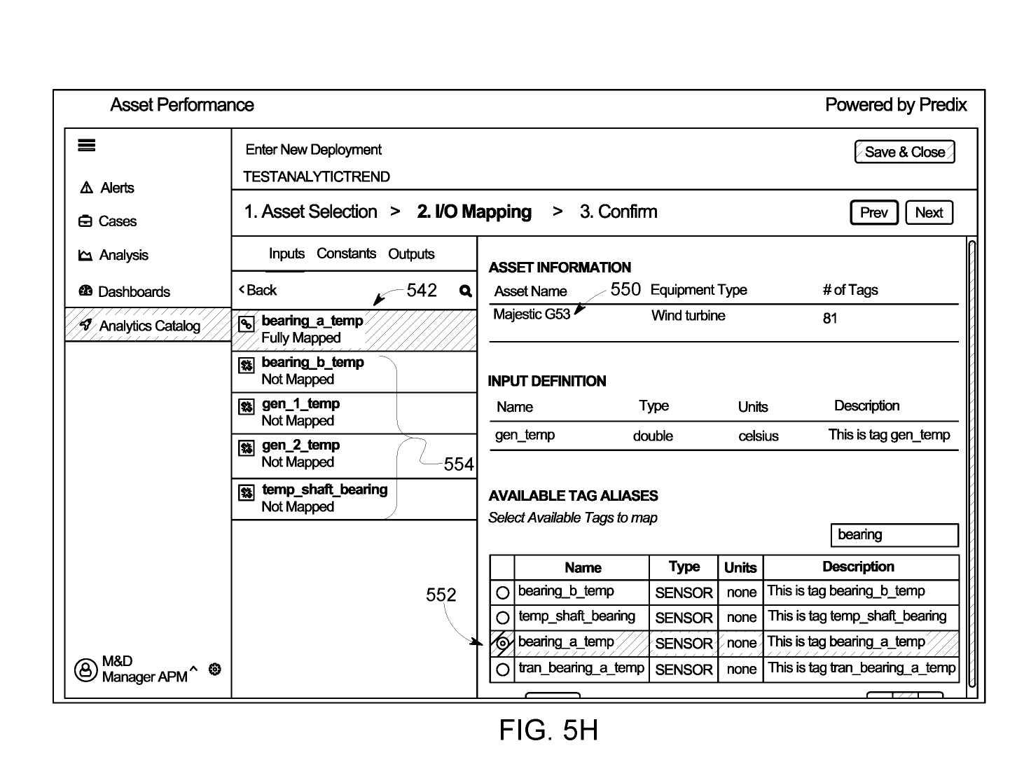

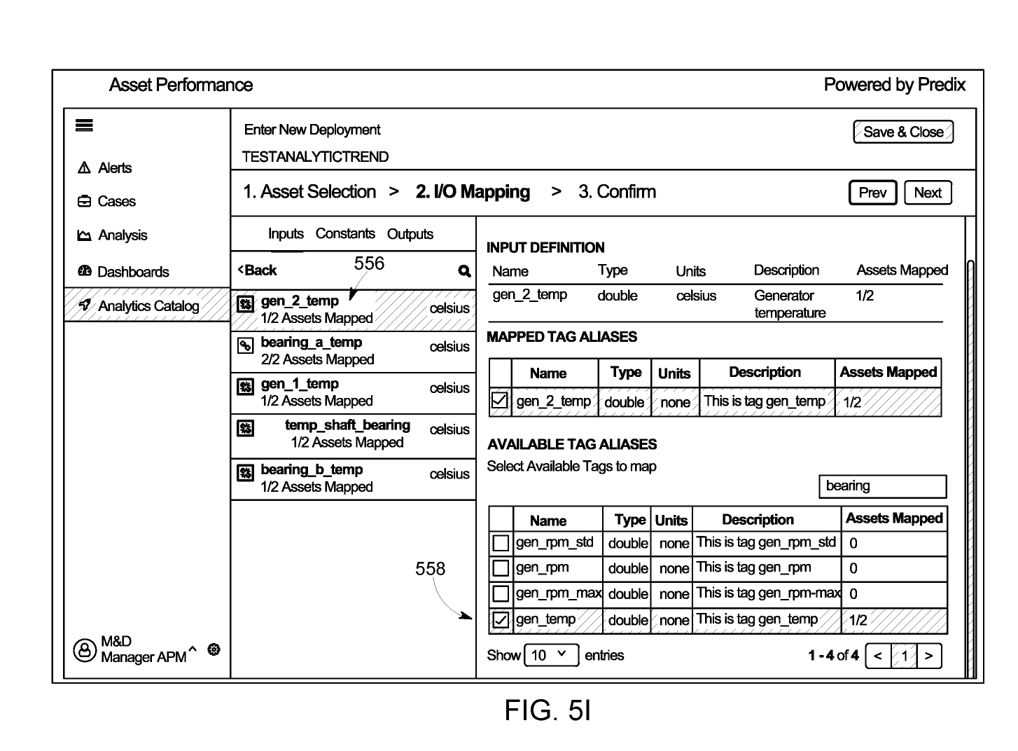

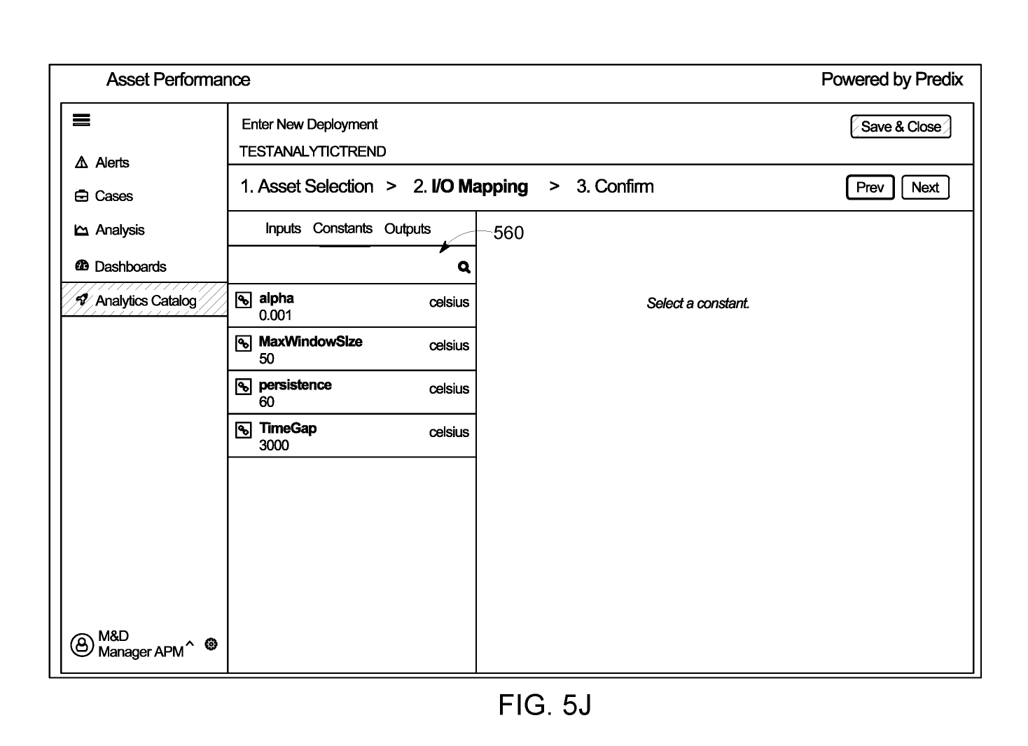

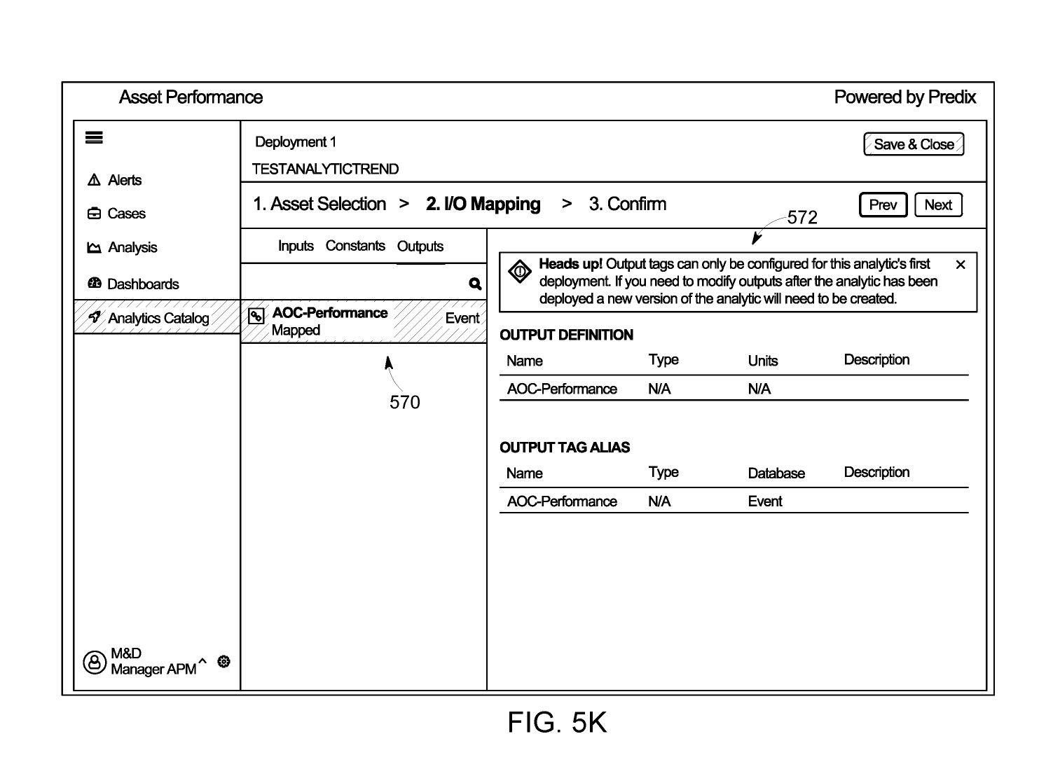

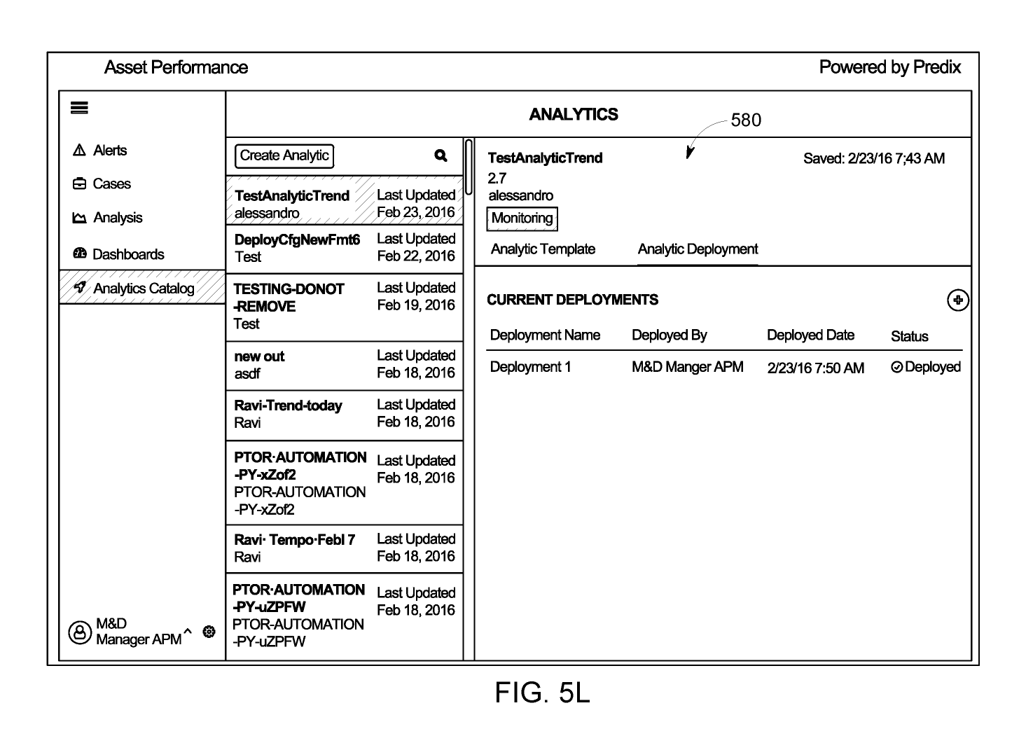

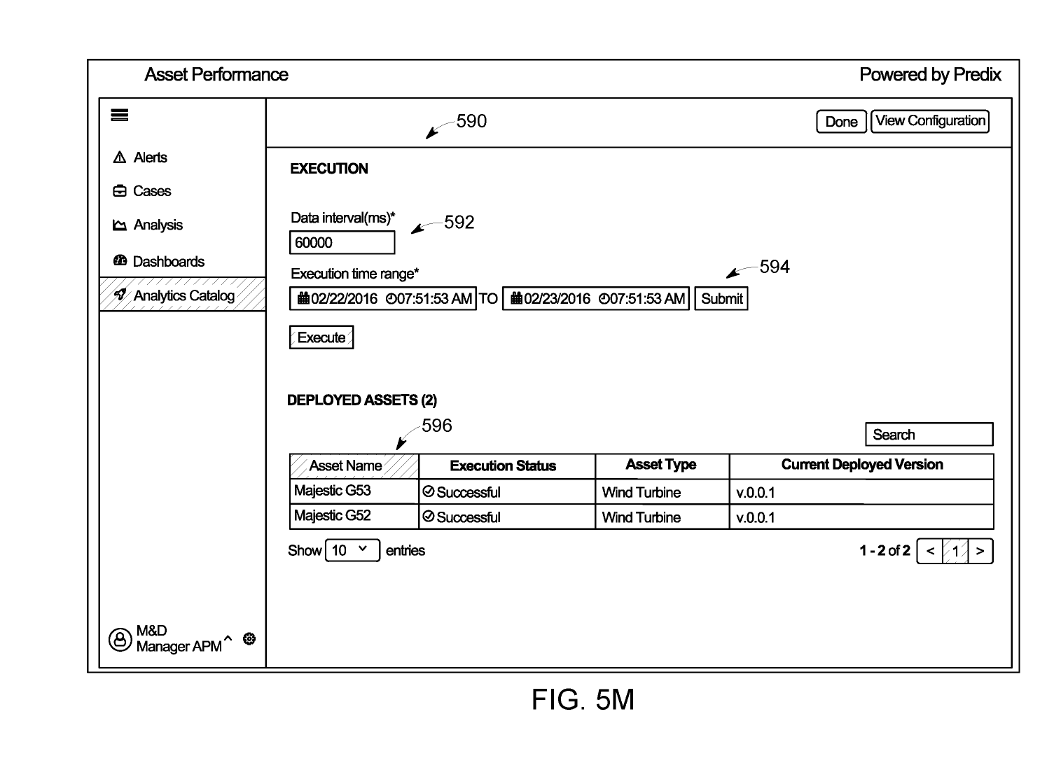

FIGS. 5A to 5M are screen shots of asset performance management (APM) analytics user interface (UI) screens in accordance with some embodiments. FIG. 5A is an example of a screen shot 500 of an Asset Performance Management (APM) user interface (UI) 500 which may appear on the display component of a user device. The APM analytics UI 500 includes a selection list 502 of action options, and in this case the user selected an “Analytics Catalog” tab. The Analytics Catalog tab selection results in a listing of analytics programs 504 and a “new analytic” input portion 506 for use by a user. In FIG. 5B, the “TestAnalyticTrend” analytics program 508 has been selected by the user, and thus an analytic template 510 is presented that includes a description field, a supporting files field, an asset applicability field, and an input definition field. In this example, a definition 512 of the “gen_2_temp” analytics input is shown, which has Celsius units and relates to Generator temperature. When the user scrolls further down the page, as shown in FIG. 5C, the user is presented with a display 514 of constants, and also may be presented with output definition(s) and/or output events. FIG. 5D shows that there are no current deployments 516 of this analytics program.

FIG. 5E is an analytic asset applicability 520 screen shot, which provides the user with a list of asset names 522, their execution status 524, and the asset type 526 name. In this case, each of the listed assets 522 on this screen shot page has a status of “not deployed,” which means that the analytic algorithm has not been run and which may mean that one or more analytic input ports have not been mapped for that asset. In some embodiments, a “Deployment Status” column is included (not shown) for the analytic algorithm, which indicates to the user whether or not the analytic algorithm is staged and ready to run (accept execution requests for that asset). In addition, in some implementations a “Mapping Status” column is included (not shown), which can be associated with each asset as well as a particular analytic algorithm, and indicates whether or not all of the required analytic input ports are mapped to a specific asset's tags. In some embodiments, the “Mapping Status” column can exhibit a “Fully Mapped” indicator (meaning that all required inputs and outputs are mapped), a “Not Mapped” indicator (meaning that none of the inputs and outputs are mapped), or a “Mapping Incomplete” indicator (meaning that some of the inputs and outputs are mapped, but others require attention). Once the selected analytic algorithm is in a fully mapped state, it can be executed or scheduled to execute by the user.

Referring again to FIG. 5E, since the analytic program “TestAnalyticTrend” will fail to run for the listed assets, the user may select the assets which were not deployed by clicking on one or more of the check boxes 528 (along with other check boxes (not shown) which may appear on the other display screens for this domain). After making the selections, the user may click on a “mapping” radio button (not shown) and be presented with the mapping screen 530 shown in FIG. 5F, wherein a “Map by Asset” option 532 and “Map by Tag” option 534 are provided. If the user selects the “Map by Asset” option 532, then the user will be provided with information to map tag definitions (analytic input ports) by each selected asset. If the user selects the “Map by Tag” option 534, then the user will be provided with information to map tag definitions (analytic input ports) by available tag aliases (the sensor names of the assets).

FIG. 5G is a “Map by Tag” screenshot page 540 showing a list of analytic input ports 542 and their status as “Not Mapped,” along with Asset Information 544 of a Wind Turbine named “Majestic G52” having 80 sensor tags. Also appearing is an Input Definition 546 of the selected input “bearing_a_temp” and a list 548 of available tag aliases (sensor names associated with the Asset “Majestic G52”). In this case, the user may scroll down the page to find an appropriate tag alias to match to the analytic input, and would continue such a process until each of the “Not Mapped” analytic inputs 542 is mapped to a tag alias of that asset.

FIG. 5H shows that the analytic input port “bearing_a_temp” is now fully mapped. In particular, the asset “Majestic G53” has a tag alias of “bearing_a_temp” 552 which is an exact match. Also shown in FIG. 5H are other analytic input ports 554 which are not mapped, and thus the user will select each of these tags one at a time and map them to an available tag alias for the asset.

FIG. 5I is a screen shot showing that the analytic input port “gen_2_temp” 556 has been mapped to one out of two assets of a domain, and that the user has matched it to the tag alias “gen_temp” 558. Thus, this screen shot indicates a fully mapped or partially mapped status to a user, wherein the X/Y indicator for assets mapped informs the user of how much of the mapping remains to be completed. In some embodiments, a number may be depicted instead that indicates the percentage mapped. In addition, the color of the analytic input port name 556 may be a red color to indicate “not mapped,” and an orange color to indicate “partially mapped,” and a green color to indicate “fully mapped.” It should be understood that other types of indicators can be utilized, for example, a “percentage mapped” number could be provided.

FIG. 5J is a screen shot illustrating the constants 560 for the “TestAnalyticTrend” analytic program for selection by the user. The constants are often single static values. In some embodiments, the constants can be provided as a list or as a table, and are specific to the selected analytic algorithm.

FIG. 5K is a screenshot showing that the analytic program “AOC-Performance” 570 is now mapped, and a message 572 is presented to the user with a warning that “Output tags can only be configured for this analytics' first deployment. If you need to modify outputs after the analytic has been deployed a new version of the analytic will need to be created.” Thus, this implementation allows the user to map an output event of an analytic algorithm to an alert template in the asset performance management (APM) analytics user interface (UI). The user need not perform such mapping and can still run the analytic algorithm, but it will not process and display alerts in the APM's alert UI. However, the user can beneficially utilize the alert template so that alerts will be processed and created in the APM alert inbox in the UI. Such alerts appear with the same name as that appearing on the screen.

FIG. 5L is a screenshot showing that the analytic program “TestAnalyticTrend” 580 has been deployed, meaning that all analytic input ports have been mapped to all assets of the domain. FIG. 5M is a screenshot of an Execution screen 590 presented to the user, which includes data interval information 592 and the execution time range 594. Also shown is a list 596 of the deployed assets and their execution status.

Thus, according to various embodiments, provided herein are systems and methods for facilitating mapping of analytic input ports to sensor tags of a community of assets. In some embodiments, the methods take advantage of standardized tag names (or the standardized sensor tags) of a community of assets to automatically map the sensor tags to the analytic input ports, and then permit users to manually map any non-standard sensor tags to the input ports of the analytic program. In some embodiments, an Asset Performance Management (APM) analytics program provides an asset tag selection user interface (UI) that allows users to automatically map standardized sensor tags to an analytic program's input ports, and for any non-standard sensor tags or outliers, users are provided with a “map by asset” option and/or a “map by tag” option. In addition, some embodiments provide an asset tag selection UI that presents simple and pleasant visual clues to guide the user in the right direction in order to utilize the map by asset and/or the map by analytic port processes to accurately and easily map alias tags (associated with the assets) to the correct analytic input ports. Thus, known pain points in the mapping process are eliminated, the user experience is greatly enhanced, and the disclosed processes save time as compared to conventional processes. Such processing also advantageously avoids human errors that can otherwise be made during the mapping process, which errors are often not discovered until much later, for example, after all of the analytic process(es) are run and the results analyzed. Accordingly, the APM analytics program having an asset tag selection service provides users with a mapping process that avoids the grunt work of manually finding matching tags to map one or more sensors, and includes the flexibility to override the auto-mapping. Such a mapping service also greatly reduces the risk of human error by detecting any changes to the analytic signature and visually indicating that to the user. In addition, such mapping processes can enable further enhancements to be made to the overall mapping process by, for example, applying behavioral learning analysis to automatically map tags.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computer-implemented method for mapping sensor tags of assets to input ports of an analytic process, comprising:
receiving, by a processor from a user device via an analytics user interface (UI), a selection by a user of an analytic process to run on a plurality of assets;
automatically mapping, by the processor, analytic input ports of the selected analytic process to sensor tags of each of the plurality of assets that have matching tag names;
determining, by the processor, that the analytic input ports have not been fully mapped to the sensor tags of at least one asset of the plurality of assets;
providing, by the processor to the user device, a map by asset option and a map by tag option for display to the user via the analytics UI;
receiving, by the processor, a selection of the map by asset option;
providing, by the processor to the user device via the analytics UI, an unmapped assets list comprising the at least one asset of the plurality of assets that are not fully mapped to the analytic input ports of the selected analytic process, and a list of tag alias names; and
receiving, by the processor from the user device via the analytics UI, a selection of an asset from the unmapped assets list and selections of tag alias names mapped by the user to the unmapped analytic input ports of the selected analytic process.

2. The computer-implemented method of claim 1, further comprising:
determining, by the processor, that mapping of sensor tags to the analytic input ports has been completed for each asset of the unmapped assets list;
running, by the processor, the selected analytic process; and
providing, by the processor, analytic output data to the user device.

3. The computer-implemented method of claim 2, further comprising:
generating, by the processor, a fully mapped assets list; and
providing, by the processor to the user device, the fully mapped assets list for display to the user via the analytics UI.

4. The computer-implemented method of claim 1, further comprising:
determining, by the processor, that mapping of sensor tags to the analytic input ports is incomplete; and
transmitting, by the processor to the user device, a prompt for the user to complete the mapping process.

5. The computer-implemented method of claim 4, wherein the prompt comprises a time limit for completing the mapping process, and further comprising:
determining, by the processor, that the time limit expired and that mapping is still incomplete;
terminating, by the processor, the analytics input port mapping process; and
transmitting, by the processor to the user device, an indication that the analytics input port mapping process has not been completed for display to the user via the analytics UI.

6. The computer-implemented method of claim 1, further comprising, prior to receiving the selection of the map by assets option:
receiving, by the processor from the user device, a selection of the map by tag option;
providing, by the processor to the user device via the analytics UI, a list of unmapped analytic input ports and associated definitions, and a list of tag alias names associated with the assets; and
receiving, by the processor from the user device via the analytics UI, selections of analytic input tags mapped by the user to the tag alias names.

7. The computer-implemented method of claim 6, further comprising:
determining, by the processor, that mapping of the analytic input ports to the tag alias names for each asset of the plurality of assets is complete;
running, by the processor, the analytic algorithm; and
providing, by the processor, analytic output data.

8. The computer-implemented method of claim 7, further comprising:
generating, by the processor, a fully mapped assets list; and
providing, by the processor to the user device, the fully mapped assets list for display to the user via the analytics UI.

9. The computer-implemented method of claim 6, further comprising:
determining, by the processor, that mapping of analytic input ports to the tag alias names is incomplete; and
transmitting, by the processor to the user device, a prompt for the user to complete the mapping process.

10. The computer-implemented method of claim 9, wherein the prompt includes a time limit for completing the mapping process, and further comprising:
determining, by the processor, that the time limit expired and that mapping is still incomplete;
terminating, by the processor, the mapping process; and
transmitting, by the processor to the user device, an indication that the analytics input port mapping process has been terminated.

11. A non-transitory computer readable medium storing instructions configured to cause a computer to:
receive, from a user device, a selection of an analytic process to run on a plurality of assets;
automatically map analytic input ports of the selected analytic process to sensor tags of each of the plurality of assets that have matching tag names;
determine that the analytic input ports have not been fully mapped to the sensor tags of at least one asset of the plurality of assets;
provide a map by asset option and a map by tag option to the user device for display to a user via an analytics UI;
receive a selection of the map by asset option;
provide an unmapped assets list comprising the at least one asset of the plurality of assets that are not fully mapped to the analytic input ports of the selected analytic process, and a list of tag alias names; and
receive a selection of an asset from the unmapped assets list and selections of tag alias names mapped by the user to the unmapped analytic input ports of the selected analytics process from the user device.

12. The non-transitory computer readable medium of claim 11, further comprising instructions configured to cause a computer to:
determine that mapping of sensor tags to the analytic input ports has been completed for each asset of the unmapped assets list;
run the selected analytic process; and
provide analytic output data to the user device.

13. The non-transitory computer readable medium of claim 12, further comprising instructions configured to cause a computer to:
generate a list of the names of fully mapped assets; and
provide a list of the fully mapped assets to the user device for display to the user via the analytics UI.

14. The non-transitory computer readable medium of claim 11, further comprising instructions configured to cause a computer to:
determine that mapping of sensor tags to the analytic input ports is incomplete; and
transmit a prompt to the user device for the user to complete the mapping process.

15. The non-transitory computer readable medium of claim 14, wherein the prompt comprises a time limit for completing the mapping process, and further comprising instructions configured to cause a computer to:
determine that the time limit expired and that mapping is still incomplete;
terminate the mapping process; and
transmit an indication to the user device that the analytics input port mapping process has not been completed for display to the user via the analytics UI.

16. The non-transitory computer readable medium of claim 11, further comprising, prior to the instructions for receiving the selection of the map by assets option, instructions configured to cause a computer to:
receive a selection of the map by tag option from the user device via the analytics UI;
provide a list of unmapped analytic input ports and associated definitions, and a list of tag alias names associated with the assets to the user device; and
receive selections of analytic input tags mapped to the tag alias names from the user device.

17. The non-transitory computer readable medium of claim 16, further comprising instructions configured to cause a computer to:
determine that mapping of the analytic input ports to the tag alias names is for each asset of the plurality of assets is complete;
run the analytic algorithm; and
provide analytic output data.

18. The non-transitory computer readable medium of claim 17, further comprising instructions configured to cause a computer to:
generate a fully mapped assets list; and
provide the fully mapped assets list to the user device for display to the user via the analytics UI.

19. The non-transitory computer readable medium of claim 16, further comprising instructions configured to cause a computer to:
determine that mapping of analytic input ports to the tag alias names is incomplete; and
transmit a prompt to the user device for the user to complete the mapping process.

20. The non-transitory computer readable medium of claim 19, wherein the prompt includes a time limit for completing the mapping process, and further comprising instructions configured to cause a computer to:
determine that the time limit expired and that mapping is still incomplete;
terminate the mapping process; and
transmit an indication to the user device that the analytics input port mapping process has been terminated.
